(19) United States
(12) Patent Application Publication
(10) Pub. No.: US 2014/0137719 A1
(43) Pub. Date: May 22, 2014

(54) Solid two-handed percussion instrument - clackers

(71) Applicant: Barbara R. Wagstaff-Walker, Saint Matthews, SC (US)

(72) Inventor: Barbara R. Wagstaff-Walker, Saint Matthews, SC (US)

(21) Appl. No.: 13/694,309

(22) Filed: Nov. 19, 2012

(51) Int. Cl. G10D 13/06

(52) U.S. Cl. CPC G10D 13/06
USPC 84/402

(57) ABSTRACT

This clacker percussion instrument is a device when used by an individual will produce musical sound and eliminate the tiring that occurs during normal clapping with bare hands. The device is made of various types of wood and shapes and can be used by children and/or adults.

### BACKGROUND OF THE INVENTION

This invention grew out of the tired hands clapping at church, concerts, football games, etc while being entertained at these different venues. People have long used many things/objects to make music. One of the most popular are the hands. However, people grow weary of clapping. Hence, enters the clackers. No problems have been encountered with this invention, it is easy to use and safe.

### BRIEF SUMMARY OF THE INVENTION

The invention provides the sound of loud clapping without tiring of the hands. It facilitates the various sounds each individual claps too. The invention allows individuals to clap freely even in the event of hand limitations.

### BRIEF DESCRIPTION OF THE VIEWS OF THE DRAWING

FIG. 1 is the side view of the clackers

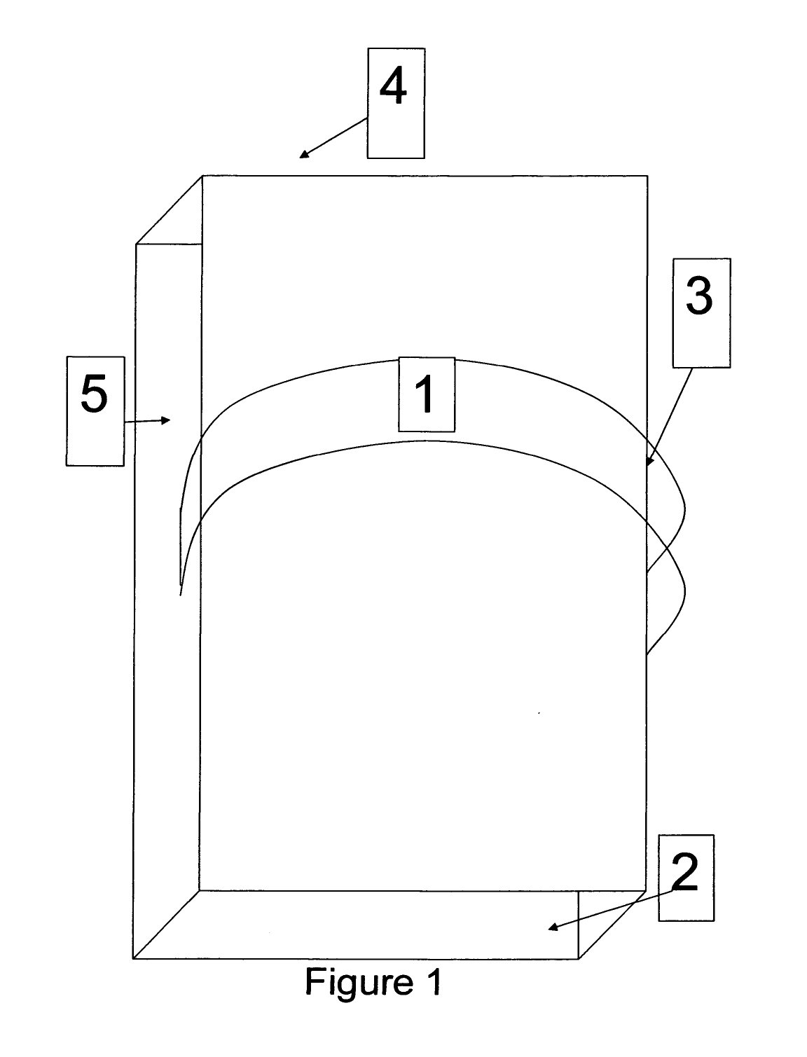

FIG. 2 is the back view of the clackers

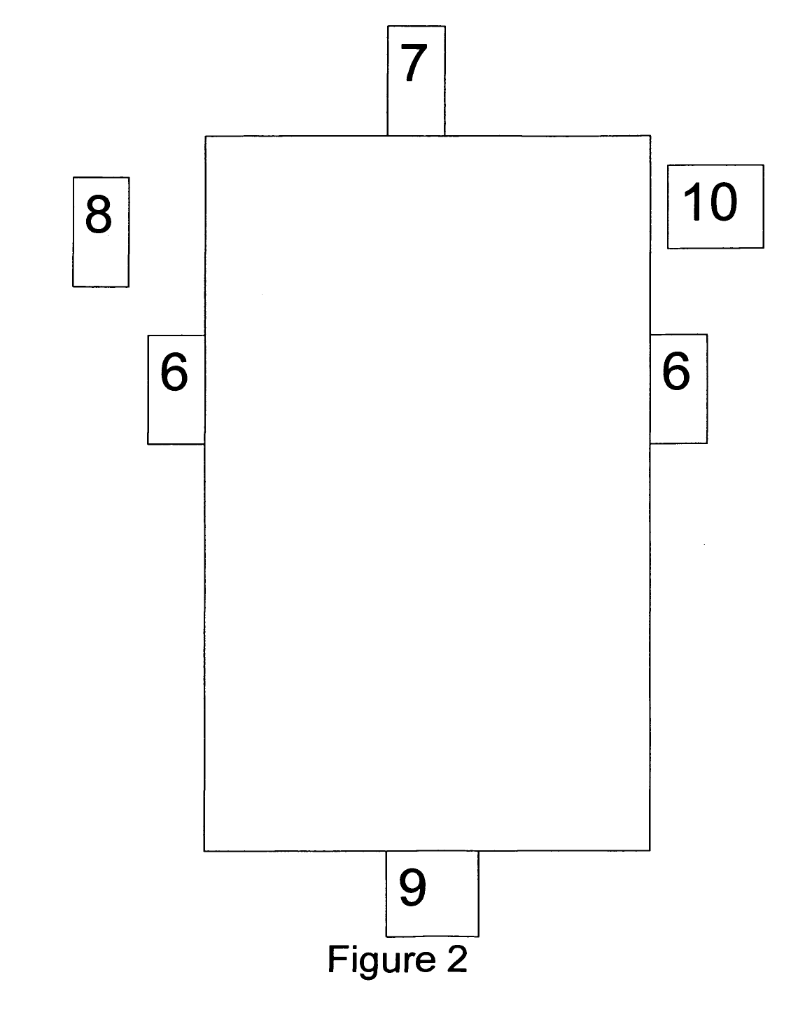

FIG. 3 is the top view of the clackers

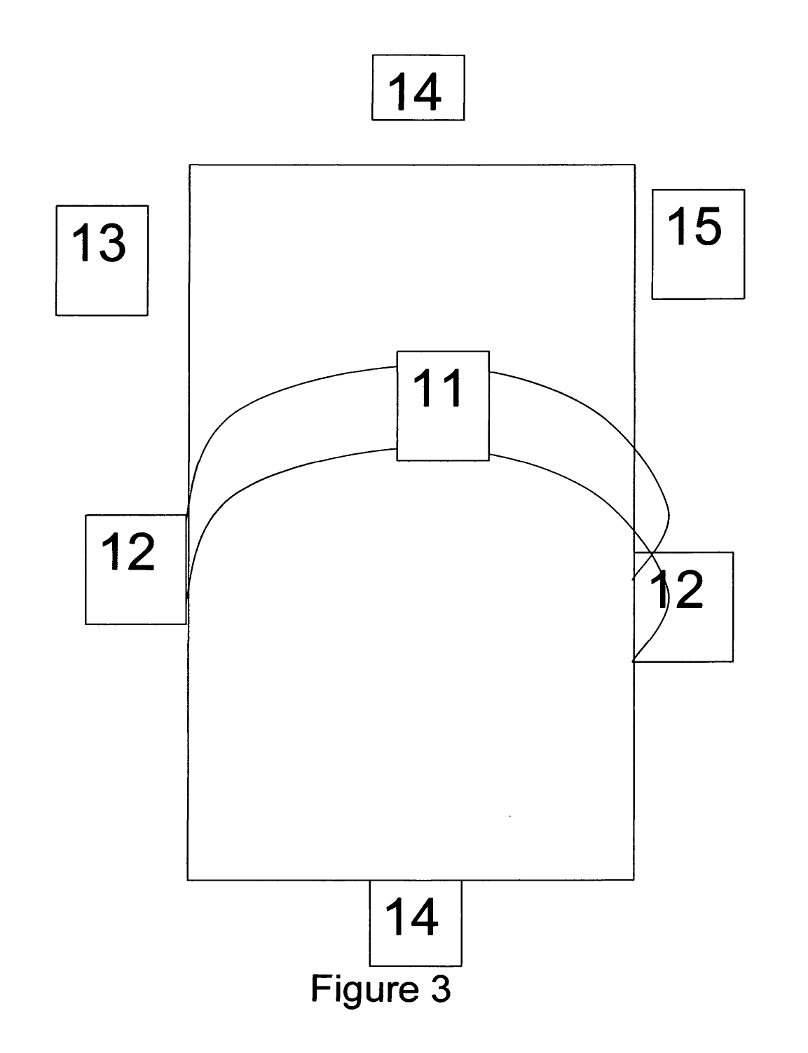

FIG. 4 is the bottom view of the clackers

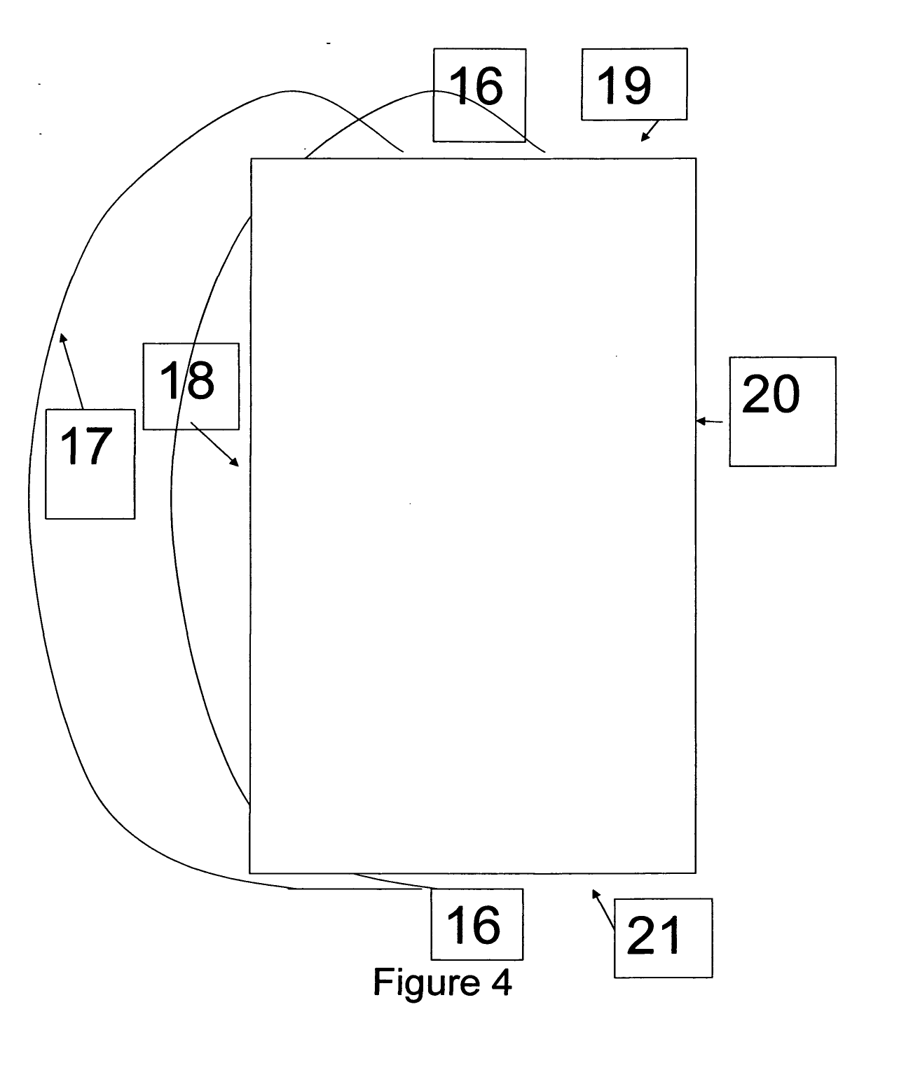

FIG. 5 is an illustration of the clackers with a hand inserted

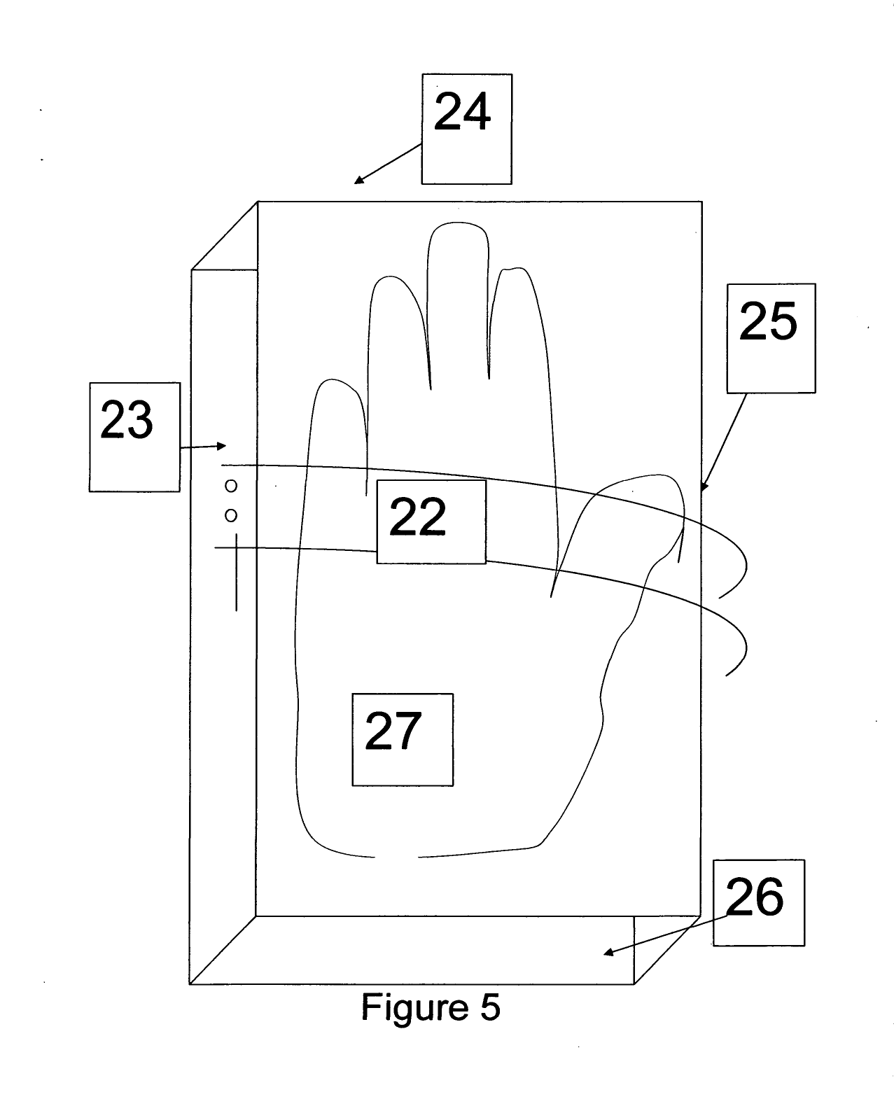

### DETAILED DESCRIPTION OF THE INVENTION

The invention provides the holding of two (2) pieces of various shaped wood in each hand with or without straps to clap together for a loud clapping sound. Depending on the size of the individual's hands and wood clackers, the sound would vary. The size would be available and adjusted for children and/or adults use. The straps will be made of lather or a pliable plastic attached to the outer sides of the wooden clacker for the purpose of securing an attachment to the hand if preferred.

The invention has now been described in detail for purposes of clarity and understanding. However, it will be appreciated that certain changes and modifications may be practiced within the scope of the append claims.

What is claimed:

1. Percussion instrument used for clapping and making various sounds.

2. Percussion instrument used for clapping and making various sounds which has a fastening strap.

3. Percussion instrument used for clapping and making various sounds which does not have a fastening strap.

4. Percussion instrument that is adaptable to individual sizing for children and/or adult hands.

5. Percussion instrument which will have different Biblical and secular inscriptions on the clacker instrument.

6. Percussion instrument which will be left without inscriptions.

7. Percussion instrument is made from various type of wood.

8. Percussion instrument is made with any dimensions for the hand.

9. Percussion instrument is made to meet all safety standards.
